(19) United States
(12) Patent Application Publication
(10) Pub. No.: US 2014/0174554 A1
(43) Pub. Date: Jun. 26, 2014

(54) Robust Quick-Connection Mechanism For Use With Valve Actuator Assemblies and Linearly Actuated Valves and Related Methods

(71) Applicant: VETCO GRAY INC., Houston, TX (US)

(72) Inventors: Sergio Felipe Meyberg, Houston, TX (US); David Daniel Comeaux, Houston, TX (US)

(73) Assignee: VETCO GRAY INC., Houston, TX (US)

(21) Appl. No.: 13/721,234

(22) Filed: Dec. 20, 2012

(51) Int. Cl. F16K 5/08

(52) U.S. Cl. CPC F16K 5/08
USPC 137/15.18; 137/315.27

(57) ABSTRACT

Apparatus and methods for connecting a linear actuating mechanism of an actuator to a valve stem of a linearly actuated valve, are provided. An example of an apparatus can include an elongate valve stem member of a valve, an extension member of a linear actuating mechanism, a locking cap member, and a locking member insertable into the locking cap member for locking the valve stem member with the extension member through employment of the locking cap member.

### BACKGROUND OF THE INVENTION

1. Field of the Invention

The present invention relates generally to valve actuation, and more particularly to apparatus and methods for actuating valves.

2. Description of Related Art

In the oil industry, valves such as gate valves are often used to open up and close off the flow of production or other fluid in a production line or other conduit. In operation, the gate valve opens up the flow of the fluid by sliding a gate out of the pathway of the fluid. There are several different types of actuated gate valves, with a common feature being that a stem of the gate valve is linearly actuated. A common methodology of actuating the gate valve is to employ a piston or other actuating mechanism connected to a valve stem of a gate, which is typically actuated either hydraulically/pneumatically or through screw gear-type mechanism.

In the hydraulic-piston methodology, direct or indirect hydraulic actuation is utilized to linearly position the gate valve to restrict or shut off fluid flow in a conduit running transverse to the gate. In a typical configuration, a spring positioned within the housing of the actuator, circumscribing the actuating mechanism/piston, is placed in compression during a positive actuator stroke to allow or turn on the fluid flow and extends to counter-stroke the piston or other actuating mechanism when the hydraulic motivation is removed to thereby close the fluid pathway.

There are two primary types of actuator: unitized and non-unitized. In an example of a non-unitized actuator, the actuator housing and components are, in essence, built on top of the valve, typically through a bonnet connecting the gate housing or pipeline/conduit to the actuator housing and components, in contrast to being brought in as a sub-assembly and coupled to the valve sub-assembly. In such configuration, the actuator requires substantial disassembly to disconnect the valve stem from the actuator mechanism. As such, in-the-field make-up and break-out is generally not feasible and takes an inordinate amount of time to accomplish. Typically, the entire actuator, bonnet, and section of pipeline containing the gate must be transferred to a fixed facility for assembly, disassembly, and/or maintenance.

In a unitized actuator, a quick-connection mechanism is provided to allow the valve stem of the gate valve to connect the actuator mechanism of the actuator assembly. Such current methodology of attaching unitized actuators to valves result in excessive play between the actuator piston and the valve stem. This inherent looseness between the actuator quick-connect feature and valve stem results in a higher degree of misalignment of the actuator piston as it compresses the coil spring during its stroke. This misalignment of the actuator piston results in accelerated actuator wear, creating diminished performance and accelerated deterioration of sealing elements.

### SUMMARY OF THE INVENTION

Recognized, therefore, is the need for an apparatus for connecting a piston or other linear actuating mechanism of a unitized actuator to a valve stem of a linearly actuated valve. In view of the foregoing, various embodiments of the present invention advantageously include apparatus and methods for connecting a piston or other linear actuating mechanism of an actuator, e.g., unitized actuator, to a valve stem of a linearly actuated valve. According to various embodiments, the made-up connection can advantageously provide for rigid, robust alignment of the actuator drivetrain. In addition, the made-up connection can provide for a robust interface between the actuator piston and the valve stem. Advantageously, according to one or more embodiments, connection make-up time and ease is comparable to or exceeds that of state-of-the art quick-connections.

According to various embodiments, when the actuator is assembled to a valve subassembly, i.e. when the stem is engaged to the gate, which, in turn is sandwiched between valve seats, it is desired that the process does not impart a torque on the gate and seats. Additionally, it is desired that the process avoid the necessity of rotating the whole actuator assembly during make-up because it is impractical and because it is desired that the process not result in imparting a significant amount of torque on the seals. Apparatus and methods according to various embodiments can advantageously create a rigid connection between the valve stem and the piston or other actuating mechanism that beneficially eliminates the need to rotate the valve stem or the piston to generate the connection, and/or which provides improved actuator performance by providing for robust alignment of a unitized actuator to a valve assembly via a quick connect-type feature.

An example of an embodiment of an apparatus for connecting a linear actuating mechanism of an actuator, e.g., a unitized actuator, to a valve stem of a linearly actuated valve can beneficially include an elongate valve stem member of a valve having a grooved outer surface profile extending along an outer surface portion of an outer surface of the valve stem member. The apparatus also includes a linear actuating mechanism of an actuator comprising a piston. In an exemplary embodiment, the piston includes a piston main body and an extension member extending longitudinally therefrom aligned coaxially with a piston body main axis. The extension member includes a threaded profile circumscribing substantial portions of an outer surface thereof, and a bore extending therein aligned coaxially with the piston main body. The bore is sized to receive distal end portions of the valve stem member to thereby centralize the valve stem member longitudinally along the piston body main axis. A tapered recess extends into the extension member, coaxially with the extension member and piston, and has a tapered inner surface profile such that the inner diameter is larger at an entrance thereto than at inner surface portions of the recess.

The apparatus also includes a segmented locking member comprising a plurality of engagement members (e.g., dogs) each having a radially oriented bore extending through main body portions thereof to provide a pathway for a support ring, which extends therethrough. Each of the plurality of engagement members further include a grooved inner surface profile configured to complement the grooved outer surface profile extending along the outer surface portion of the outer surface of the valve stem member to lockingly engage therewith. Each of the engagement members also have a tapered outer surface profile configured to engage inner surface portions of the tapered recess extending into the extension member when urged therealong.

The apparatus further includes a locking cap member having a first end portion, a second end portion, a main body portion extending therebetween, an aperture extending through a proximal-facing outer surface of the first end portion, sized to receive the distal end portions of the valve stem member, and a bore extending longitudinally therein from the second end portion, substantially through the main body portion to receive portions of the extension member. The aperture has an inner diameter that is substantially smaller than the inner diameter of portions of the bore adjacent thereto to thereby form an annular shoulder therewith sized to operably engage proximal-facing portions of the plurality of engagement members of the segmented locking member. The bore has a threaded profile extending along substantial portions of the inner diameter thereof. The threaded profile of the bore complements the threaded profile circumscribing an outer surface portion of the outer surface of the extension member to threadingly engage therewith. This, advantageously, results in or otherwise causes the annular shoulder to urge the plurality of engagement members into engagement with the inner surface portions of the tapered recess extending into the extension member and into locking engagement with the grooved outer surface profile extending along the outer surface portion of the outer surface of the valve stem member, when threaded thereon.

An example of an embodiment of a method of connecting a linear actuating mechanism (e.g., a piston or other such member) of an actuator, e.g., a unitized actuator, to a valve stem of a linearly actuated valve can include the step of providing the actuator, a dog ring or other locking member, a washer or bearing, a locking cap member, and a modified valve stem member according to various configurations. In the exemplary method of connecting the piston or other such linear actuating mechanism of an actuator to a valve stem of a linearly actuated valve, the method further includes the steps of inserting the washer or bearing and the dog ring into the locking cap member, extending distal end portions of the distal end of the elongate valve stem member through the aperture in the locking cap member, through the aperture in the washer or bearing once or one, and through a passageway defined by inner surface portion of the dogs of the dog ring. The steps can also include inserting distal end portions of the distal end of the valve stem member into the bore of the piston extension member to align the elongate valve stem member coaxially with a piston main body to thereby centralize the elongate valve stem member longitudinally along a piston body main axis.

The steps also include urging the tapered outer surface profile of the plurality of dogs into engagement with the inner surface portions of the tapered recess extending into the piston extension member to thereby longitudinally slide the grooved inner surface profiles of the plurality of dogs into locking engagement with the grooved outer surface profile of the valve stem member. The step of urging the tapered outer surface profile of the plurality of dogs into engagement with the inner surface portions of the tapered recess extending into the piston extension member typically includes rotating the locking cap member to thereby longitudinally slide the grooved inner surface profile of the plurality of dogs into locking engagement with the grooved outer surface profile of the valve stem member. The steps also include lockingly engaging the grooved inner surface profile of the plurality of dogs with the grooved outer surface profile of the valve stem member.

The steps also include releasing a locked connection between the elongate valve stem member and the piston by removing the locking cap member. The removal of the locking cap member results in the release of the locked engagement of the grooved inner surface profile of each of the plurality of dogs with the grooved outer surface profile of the valve stem member, allowing the valve stem to be retracted from within the extension member. The removal of the locking cap member results in the disengagement of the tapered outer surface profile of the plurality of dogs from with the inner surface portions of the tapered recess extending into the piston extension member, allowing the longitudinal movement of the plurality of dogs and the valve stem member without necessitating the release of the locked engagement of the grooved inner surface profile of each of the plurality of dogs with the grooved outer surface profile of the valve stem member, thereby allowing the valve stem to be retracted from within the extension member.

### BRIEF DESCRIPTION OF THE DRAWINGS

So that the manner in which the features and advantages of the invention, as well as others which will become apparent, may be understood in more detail, a more particular description of the invention briefly summarized above may be had by reference to the embodiments thereof which are illustrated in the appended drawings, which form a part of this specification. It is to be noted, however, that the drawings illustrate only various embodiments of the invention and are therefore not to be considered limiting of the invention's scope as it may include other effective embodiments as well.

FIG. 1a is a partially exploded schematic diagram of an apparatus for connecting a linear actuating mechanism of a unitized actuator to a valve stem of a linearly actuated valve, showing the linear actuating mechanism in an upstroke according to an embodiment of the present invention.

FIG. 1b is a partially exploded schematic diagram of the apparatus illustrated in FIG. 1a showing the linear actuating mechanism in a downstroke according to an embodiment of the present invention.

FIG. 2 is a schematic diagram of the apparatus illustrated in FIGS. 1a-1b according to an embodiment of the present invention.

FIG. 3 is a schematic diagram of portions of the apparatus illustrated in FIG. 2 taken along the 3-3 line according to an embodiment of the present invention.

FIG. 4 is a schematic diagram of a tool for rotating a locking cap member of the apparatus illustrated in FIG. 2 according to an embodiment of the present invention.

FIG. 5 is a schematic diagram of an apparatus for connecting a linear actuating mechanism of a unitized actuator to a valve stem of a linearly actuated valve, similar to that of FIG. 2, but having an intermediate extension member in a different internal piston configuration to accommodate the stroke of the piston according to an embodiment of the present invention.

FIG. 6 is a schematic diagram of an apparatus for connecting a linear actuating mechanism of a unitized actuator to a valve stem of a linearly actuated valve according to an embodiment of the present invention.

FIG. 7 is a schematic diagram of portions of the apparatus illustrated in FIG. 6 taken along the 6-6 line according to an embodiment of the present invention.

FIG. 8 is a schematic diagram of an apparatus for connecting a linear actuating mechanism of a unitized actuator to a valve stem of a linearly actuated valve according to an embodiment of the present invention.

FIG. 9 is a schematic diagram of an apparatus for connecting a linear actuating mechanism of a unitized actuator to a valve stem of a linearly actuated valve according to an embodiment of the present invention.

FIG. 10 is a schematic diagram of an apparatus for connecting a linear actuating mechanism of a unitized actuator to a valve stem of a linearly actuated valve according to an embodiment of the present invention.

### DETAILED DESCRIPTION

The present invention will now be described more fully hereinafter with reference to the accompanying drawings, which illustrate embodiments of the invention. This invention may, however, be embodied in many different forms and should not be construed as limited to the illustrated embodiments set forth herein. Rather, these embodiments are provided so that this disclosure will be thorough and complete, and will fully convey the scope of the invention to those skilled in the art.

Current methods of unitized actuator attachment to valves result in excessive play between the piston of the actuator and the valve stem. This inherent looseness between the actuator fast- or quick-connect feature and valve stem results in a higher degree of misalignment of the actuator piston as it compresses the coil spring during its stroke. This misalignment of the actuator piston results in accelerated actuator wear, creating diminished performance and sealing element issues.

Various embodiments of the present invention can allow for the make-up and break-out of an actuator such as, for example, a unitized actuator, to a valve assembly in a quick and positive manner. The made-up connection can provide for rigid, robust alignment of the actuator drivetrain. In addition, the made-up connection can provide for a robust interface between the actuator piston and the valve stem. Connection make-up time and ease according to one or more embodiments of the present invention is comparable to or exceeds that of state-of-the art quick-connections. Further, apparatus and methods according to various embodiments of the present invention can create a rigid connection between the valve stem and the piston or other actuating mechanism that advantageously eliminates the need to rotate the valve stem or the piston to generate the connection, and/or which provides improved actuator performance by providing for robust alignment of an actuator assembly to a valve assembly via quick connect feature.

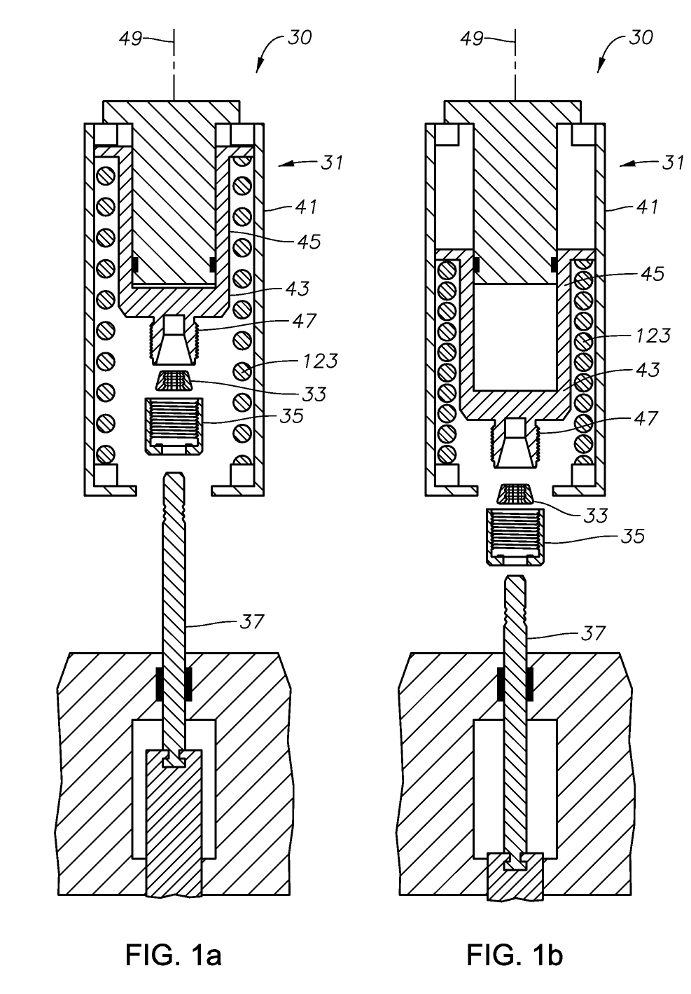

FIGS. 1A-1B illustrate an example of an apparatus 30 for connecting a linear actuating mechanism of an actuator 31 to a valve stem of a linearly actuated valve (not shown). According to the illustrated embodiment, the apparatus 30 includes a locking member 33, a locking cap member 35, and a typically elongate valve stem member 37 to connect the linear actuated valve to the actuator 31. The actuator 31 includes an actuator housing 41 and a piston 43 or other linear actuating member. The piston 43 includes a main body 45 contained within the actuator housing 41 and an extension member 47 extending longitudinally therefrom, aligned coaxially with the main axis 49 of the main body 45 of the piston 43. Note, according to the exemplary configuration, the extension member 47 and/or piston 43 form part of the apparatus 30.

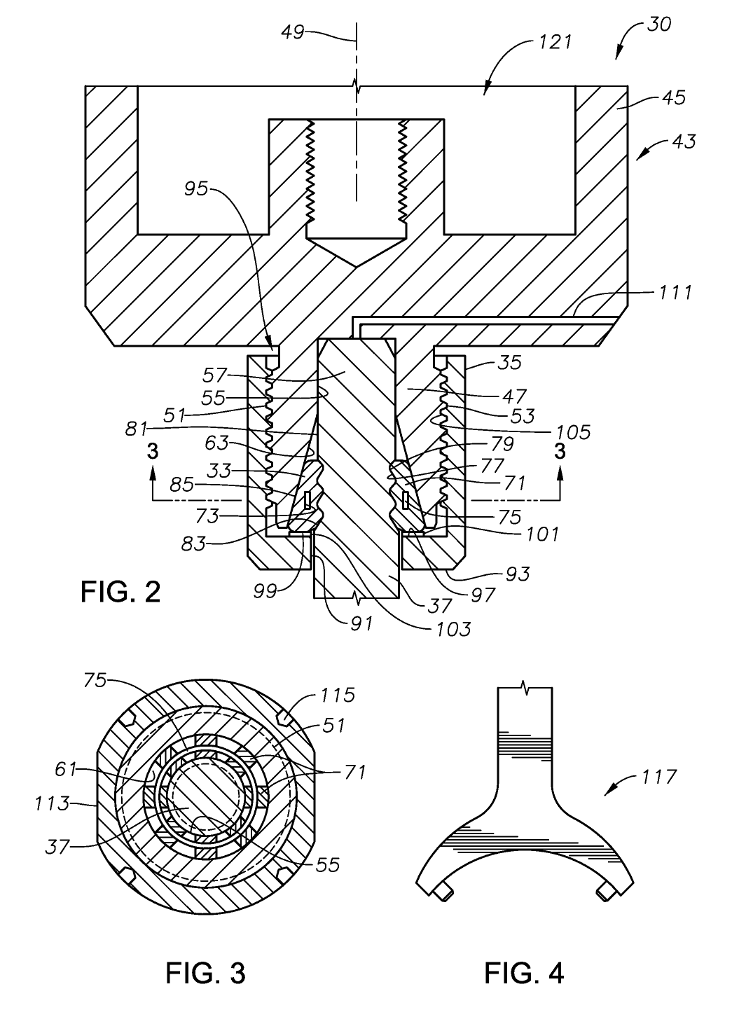

Referring to FIG. 2, the extension member 47 has a threaded profile 51 circumscribing substantial portions of an outer surface 53 thereof, and a bore 55 (elongate recess) extending therein aligned coaxially with the piston main body 45 and sized to receive distal end portions 57 of the valve stem member 37 to thereby centralize the valve stem member 37 longitudinally along the main axis 49 of the piston 43. The extension member 47 also has a coaxially extending tapered recess 61 having a tapered inner surface profile 63 such that the inner diameter is larger at an entrance thereto than at inner surface portions of the tapered inner surface profile 63.

The apparatus 30 also includes a segmented locking member 33, such as, for example, a dog ring 33 having a plurality of dog-type engagement members or dogs 71. An exemplary configuration, dogs 71 each have a circumferentially oriented bore 73 extending through main body portions thereof. A support ring 75, which can be segmented or non-segmented, extends through the body of the dogs 71 to hold the dogs 71 centered around the valve stem member 37 during assembly of the piston 43 onto the valve stem 37, which may be in a horizontal position during assembly. Each of the plurality of dogs 71 can include a grooved inner surface profile 77 configured to complement a grooved outer surface profile 79 extending along an outer surface portion of the outer surface 81 of the valve stem member 37 to lockingly engage therewith.

In the exemplary configuration, the grooved inner surface profile 77 of each of the plurality of dogs 71 comprises a plurality of circumferentially oriented ramp sections 81, typically providing a saw-toothed profile in cross-section. Similarly, the grooved outer surface profile 79 of the elongate valve stem member 37 comprises a plurality of annular ramp sections 83 having a surface contour that complements a surface contour of the plurality of annular oriented ramp sections 81, also typically providing a saw-toothed profile in cross-section as well. Each of the dogs 71 also have a tapered outer surface profile 85 configured to engage inner surface portions of the tapered recess 61, having profile 63, extending into the extension member 47 when urged therealong. According to an exemplary embodiment, as a result of the orientation of the dogs 71, and the general direction of the load imparted by the ramp sections 81 and movement resulting from engagement of the mating surfaces is in a radial direction, with an axial preload component contributing to the rigidity of the connection. Note, the dogs 71 may take the form of a segmented ring with the necessary profiles on the ID and OD. The dogs 71 do not have to have a large gap in between them.

The apparatus 30 also includes a locking cap member 35 having an aperture 91 extending through a proximal-facing outer surface 93, sized to receive the distal end 57 of the valve stem member 37, and a bore 95 extending longitudinally therein from the distal end, substantially through the main body to receive at least substantial, if not complete, portions of the extension member 47. The aperture 91 has an inner diameter that is substantially smaller than the inner diameter of the bore 95 adjacent thereto to thereby form an annular shoulder 97 sized to operably engage proximal-facing portions 99 of the plurality of dogs 71 of the dog ring 33. The “operable engagement” can be through either direct contact or through indirect contact. As an example of indirect contact, in the exemplary configuration, a washer or bearing 101 having an aperture 103 sized to receive the elongate valve stem member 37 is positioned between the proximal-facing portions 99 of the plurality of dogs 71 of the dog ring 33 and the distal-facing portion of the annular shoulder 97 of the locking cap member 35.

In the exemplary embodiment, the bore 95 of the locking cap member 35 has a threaded profile 105 extending along substantial portions of the inner diameter 17 thereof, which complements the threaded profile 51 circumscribing an outer surface portion of the outer surface 53 of the extension member 47 to threadingly engage therewith. This provides an effect such that when the locking cap member 35 is rotated, the linear travel of the locking cap member 35 resulting from the travel along the threads causes the annular shoulder 97 to urge the plurality of dogs 71 into engagement with the inner surface portions of the tapered recess 61 extending into the extension member 47, moving the grooved inner surface profile 77 of the dogs 71 into locking engagement with the grooved outer surface profile 79 of the valve stem member 37.

In the exemplary configuration, the bore 55 of the extension member 47 is cylindrical in shape and has an inner surface diameter matching, within very tight tolerances, the outer surface diameter of the distal end 57 of the valve stem member 37 to provide for establishing the rigid alignment. The distal most portion of the distal end 57 can have a rounded or frustoconical shape to provide for ease of insertion. Additionally, a fluid vent and anti-pressure lock conduit 111 is located in fluid contact with the bore 55 to provide fluid venting therefrom when the distal end 57 of the valve stem member 37 is inserted therein to facilitate make-up, and to provide pressure equalization during extraction thereof to facilitate breakdown.

Referring to FIGS. 3 and 4, in the exemplary configuration, the outer surface of the locking cap member 35 can include at least a pair of wrench flats 113, or a series of recesses 115 or apertures engageable by a tool such as tool 117. A wrench (not shown), tool 117, or other tool (not shown) can be used to tighten the locking cap member 35 to establish the rigid connection between the valve stem member 37 and the actuator 31. In order to release the connection, according to an exemplary configuration, the connection can be released by loosening and then removing the locking cap member 35. In order to improve the speed and reduce the number of turns, the coupling between the locking cap member 35 and the extension member 47 can have a multiple thread start.

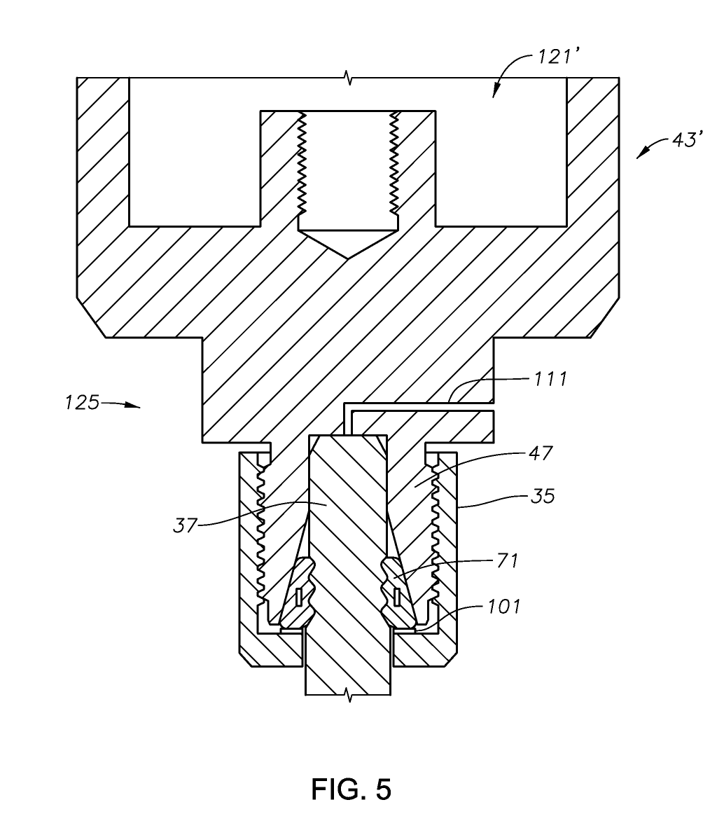

Referring again to FIG. 2 as well as FIG. 5, the interior 121, 121′, of the piston 43, 43′ sees hydraulic fluid pressure which results in its displacement within the actuator housing 31. In the two illustrated configurations, once fluid pressure is evacuated, spring assembly 123 (FIG. 1) returns the piston 43 to its original position. In order to accommodate the stroke of the piston, the piston may be configured as shown in FIG. 5 to include an intermediate extension portion 125. In this configuration, the fluid vent and anti-pressure lock conduit 111 will typically be routed through the intermediate extension 125 rather than through the main body of piston 43′.

In operation, the unitized actuator 31, the locking member, e.g., dog ring 33, the washer or bearing 101, the locking cap member 35, the modified valve stem member 37, and, e.g., piston extension member 47, according to the various configurations described above, are provided. In the exemplary operation of connecting the piston 43 or other such linear actuating mechanism of actuator 31 to a valve stem of a linearly actuated valve, the operation includes the steps of inserting the washer or bearing 101 and the dog ring 33 into the locking cap member 35, extending distal end portions of the distal end 57 of the elongate valve stem member 37 through the aperture 91 in the locking cap member 35, through the aperture in the washer or bearing 101, and through a passageway defined by inner surface portion of dogs 71. The steps can also include inserting distal end portions of the distal end 57 of the valve stem member 37 into the bore 55 of the piston extension member 47 to align the elongate valve stem member 37 coaxially with a piston main body 45 to thereby centralize the elongate valve stem member 37 longitudinally along a piston body main axis 49.

The steps also include urging the tapered outer surface profile 85 of the plurality of dogs 71 into engagement with the inner surface portions of the tapered recess 61 extending into the piston extension member 47 to thereby longitudinally slide the grooved inner surface profiles 77 of the plurality of dogs 71 into locking engagement with the grooved outer surface profile 79 of the valve stem member 37. The step of urging the tapered outer surface profile 85 of the plurality of dogs 71 into engagement with the inner surface portions of the tapered recess 61 extending into the piston extension member 47 includes rotating the locking cap member 35 to thereby longitudinally slide the grooved inner surface profile 77 of the plurality of dogs 71 into locking engagement with the grooved outer surface profile 79 of the valve stem member 37. The steps also include lockingly engaging the grooved inner surface profile 77 of the plurality of dogs 71 with the grooved outer surface profile 79 of the valve stem member 37.

According to the exemplary configuration, the outer diameter of the distal end portions of the distal end 57 of the valve stem member 37 and the inner diameter of the bore 55 of the piston extension member 47 are sized, and the connection between the grooved inner surface profile 77 of the dogs 71 and the grooved outer surface profile 79 of the valve stem member 37 and between the outer surface profile 85 of the plurality of dogs 71 and the tapered inner surface profile 63 of the extension member 47 are sized and configured to provide a sliding fit at least to the standard described in ANSI B4.1-1967, section RC2, but more preferably to the standard described in section RC1, to thereby provide for establishing a precision fit with effectively little to no play therebetween sufficient to minimize undue vibrations and substantially extend the life of the pump and actuator components beyond that of capable of prior quick-connect type arrangements.

As part of a breakdown operation, the steps can also include releasing the locked connection between the elongate valve stem member 37 and the piston 43 by removing the locking cap member 35, with the removal releasing the locked engagement of the grooved inner surface profile 77 of each of the plurality of dogs 71 with the grooved outer surface profile 79 of the valve stem member 37. Beneficially, according to the exemplary configuration, removal of locking cap member 35 allows disengagement of tapered surfaces on dogs 71 from tapered surface on valve stem member 37 (e.g., piston extension), and therefore, disengagement of the valve stem member 37 from the piston 43 is possible without the need to disengage the dogs 71 from the valve stem member 37. I.e., if binding of the dogs 71 to valve stem member 37 occurs, then there is no difficulty disengaging the actuator 31 from the valve stem member 37.

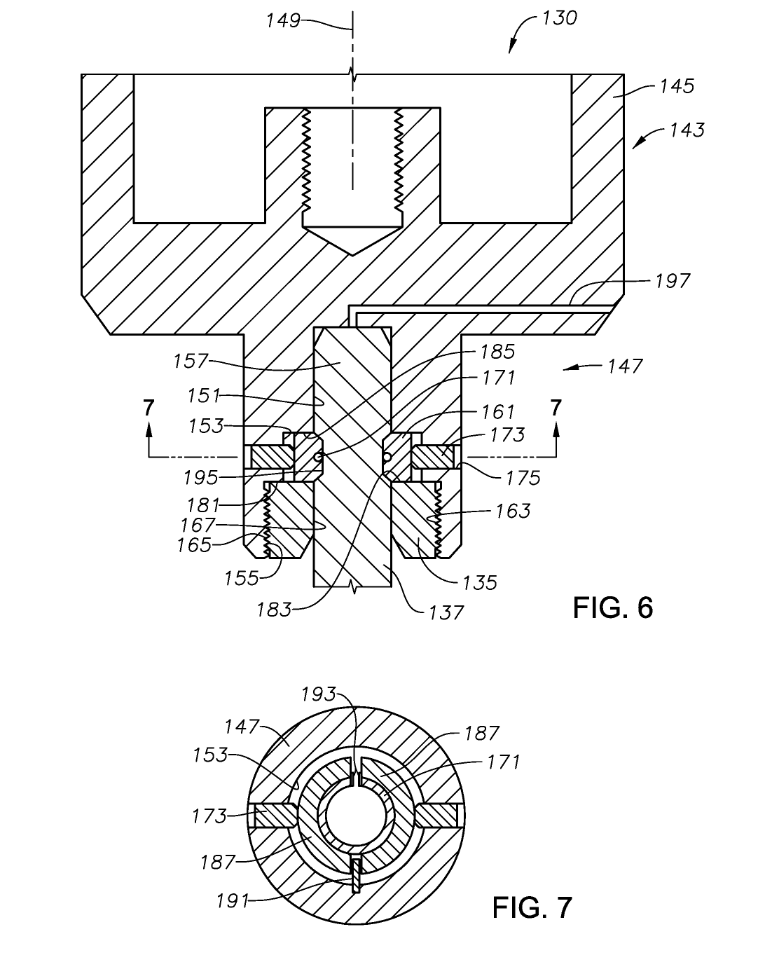

FIG. 6 illustrates an apparatus 130 for connecting a linear actuating mechanism of an actuator to a valve stem of a linearly actuated valve. According to the exemplary configuration, the apparatus 130 includes a locking ring assembly 133, a retaining gland 135, a elongate valve stem member 137, and one or more actuator interface components. According to the exemplary configuration, the unitized actuator (see, e.g., actuator 31, FIG. 1) contains a piston 143 having a main body 145 contained within a housing 41 of the actuator and an extension member 147 extending longitudinally therefrom, aligned coaxially with the main axis 149 of the main body 145 of the piston 143. Note, according to the exemplary configuration, the extension member 147 and/or piston 143 form part of the apparatus 130.

According to the illustrated configuration, the extension member 147 has a bore 151, a first counterbore 153, and a second counterbore 155, each aligned coaxially with the piston main body 145 along the main axis 149. The bore 151 is sized to tightly slidably receive distal end portions 157 of the valve stem member 137, with a minimal or approximately zero amount of force. The first counterbore 153 is sized to receive a typically segmented locking ring 161 of the locking ring assembly 133. The second counterbore 155 is sized to receive the retaining gland 135, and has a threaded profile 163 circumscribing substantial inner surface portions thereof, complementing a corresponding threaded profile 165 circumscribing substantial outer surface portions of the retaining gland 135. The retaining gland 135 includes an aperture 167 extending therethrough sized to permit passage of distal end portions of the valve stem member 137.

According to the illustrated configuration, the locking ring assembly 133 includes the segmented locking ring 161, a C-ring 171 biased radially outwardly or mechanism having an equivalent function, and at least one, but more typically a plurality of setscrews 173 each sized to extend through a corresponding radially oriented hole 175 extending through portions of the first counterbore 153 of the extension member 147. When the retaining gland 135 is threaded into the second counterbore 155 typically in abutting contact with a shoulder 181, the locking ring 161 is axially constrained within an annular slot 183 formed between the retaining gland 135 and shoulder 185. In the illustrated configuration (see FIG. 7), the locking ring 161 includes a pair of locking ring segments 187. Alternative configurations, however, can include three or more locking ring segments 187. Where there are more than two locking ring segments 187, there will typically be a corresponding more than two setscrews 173.

Referring to FIG. 7, according to the illustrated configuration, a key 191 or other protuberance extends radially inwardly from the inner surface of the first counterbore 153 of the extension member 147 to prevent rotation of the lock ring segments 187. Additionally, the C-ring 171 can have a set of “feet” 193 which further help maintain the locking ring segments 187 in place.

Referring again to FIG. 6, in operation, the locking ring assembly 133 is inserted into the first counterbore 153 of the extension member 147, and the retaining gland 135 is threaded into the second counterbore 155 to secure the locking ring assembly 133 in the first counterbore 153. The distal end portions 157 of the valve stem member 137 are inserted through the retaining gland 135, through the locking ring assembly 133, into the bore 151. The plurality of setscrews 173 are each tightened inward to drive the segments 187 in the locking ring 161 into a corresponding annular recess or groove(s) 195 extending into outer surface portions of the valve stem member 137, thereby creating a rigid connection between the valve stem member 137 and the piston 143. Beneficially, the interface can provide a sliding fit at least to the standard described in ANSI B4.1-1967, section RC2, but more preferably to the standard described in section RC1, to thereby provide for establishing a precision fit with effectively little to no play therebetween sufficient to minimize undue vibrations and substantially extend the life of the pump and actuator components beyond that of capable of prior quick-connect type arrangements.

According to the exemplary configuration, a fluid vent and anti-pressure lock conduit 197 is located in fluid contact with the bore 151 to provide fluid venting therefrom when the distal end 157 of the valve stem member 137 is inserted therein to facilitate make-up, and to provide pressure equalization during extraction thereof to facilitate breakdown.

In order to release the established connection, the setscrews 173 are backed out, allowing the resilient C-ring 171 to push the locking ring segments 187 radially outwardly, which causes the locking ring segments 187 to retract from within their respective complementing portion of the groove 191 and back into the annular slot 183. Beneficially, this configuration prevents the locking ring segments 187, from falling off the assembly such as, for example, when more than two segments 187 are employed. An alternative means of disassembly includes the removal of the retaining gland 135 from the piston extension 147, thereby allowing the axial displacement of the locking ring assembly 133 and the valve stem member 137.

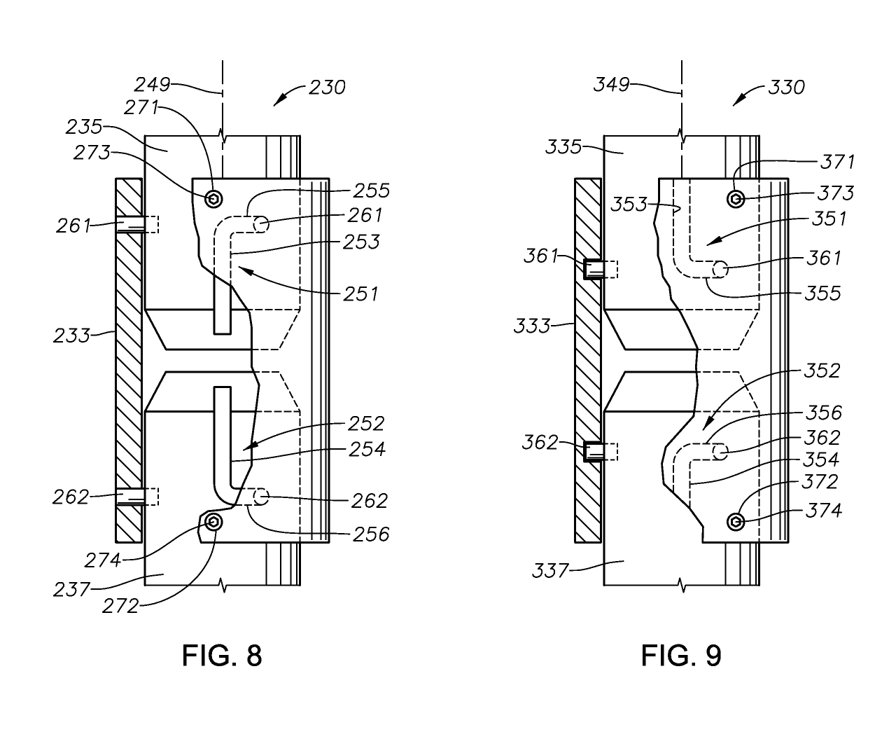

FIG. 8 illustrates an apparatus 230 for connecting a linear actuating mechanism of an actuator to a valve stem of a linearly actuated valve. According to the exemplary configuration, the apparatus 230 includes a locking sleeve or collar 233, a piston extension member 235, and a valve stem member 237. According to the exemplary configuration, the unitized actuator (see, e.g., actuator 31, FIG. 1) contains a piston (not shown) having a main body contained within a housing 41 of the actuator and the extension member 235 extending longitudinally therefrom, aligned coaxially with the main axis 249 of the main body of the piston. Note, according to the exemplary configuration, the extension member 235 and/or piston form part of the apparatus 230.

According to the illustrated configuration, the extension member 235 and valve stem member 237 each include at least one J-groove 251, 252, having a first leg 253, 254, extending from the exposed end of the extension member 235, oriented along the main axis 249, and a second leg 255, 256, oriented transverse to the main axis 249, parallel and in the same direction as each other. Correspondingly, the locking sleeve 233 includes at least one pair of pins 261, 262, or other similar protuberances positioned spaced apart at a certain distance so that when the extension member 235 and the valve stem member 237 are aligned and in contact, when the pins 261, 262, are inserted into the corresponding first 253, 254, of the J-groove 251, 252, and when the locking sleeve 233 is rotated, the pins 261, 262, interface with and become secured within the second leg 255, 256, of the J-grooves 251, 252, to establish a rigid connection between the extension member 235-piston and the valve stem member 237-linear actuated valve, locking the relative axial position of the respective components.

According to the exemplary configuration, the locking sleeve 233 can include one or more pairs of recesses or holes (not shown) similar to those shown in FIG. 4, for example, sized and spaced apart to receive a tool such as, for example, tool 117 shown in FIG. 4, or one or more pairs of flats similar to those shown in FIG. 4, for example, can receive a wrench for rotating the locking sleeve 233. The body of the locking sleeve 233 can also include a plurality of radially oriented set-screw holes 271, 272, sized to receive a corresponding plurality of setscrews 273, 274, positioned to prevent inadvertent unlocking of the locking sleeve 233 from piston extension member 235 and valve stem member 237. The inner surface of the locking sleeve 233 can include a groove (not shown), for example, operably extending longitudinally between the ends of the sleeve 233 according to a pattern understood by one of ordinary skill in the art, or other pressure relief mechanism. In addition to or alternatively, a pressure relief groove (not shown), for example, can have portions in the outer surface of extension member 235 and portions in the outer surface of the valve stem number 237. One of the groove portions in one of the members 235, 237, can radially/diametrically and perpendicularly intersect with the other during operable engagement therebetween.

FIG. 9 illustrates an apparatus 330 for connecting a linear actuating mechanism of an actuator to a valve stem of a linearly actuated valve. According to the exemplary configuration, the apparatus 330 includes a locking sleeve or collar 333, a piston extension member 335, and a valve stem member 337. According to the exemplary configuration, the unitized actuator (see, e.g., actuator 31, FIG. 1) contains a piston (not shown) having a main body contained within a housing 41 of the actuator and the extension member 335 extending longitudinally therefrom, aligned coaxially with the main axis 349 of the main body of the piston. Note, according to the exemplary configuration, the extension member 335 and/or piston form part of the apparatus 330

According to the illustrated configuration, the extension member 335 and valve stem member 337 each include at least one pin 361, 362, or other similar protuberances. Correspondingly, the locking sleeve 333 includes at least one pair of J-grooves 351, 352, having a first leg 353, 354, extending from the exposed end of the extension member 335, oriented along the main axis 349, and a second leg 355, 356, oriented transverse to the main axis 349, parallel and in the same direction as each other.

The J-grooves 351, 352, are positioned spaced apart at a certain distance so that when the extension member 335 and the valve stem member 337 are aligned and in contact, when the pins 361, 362, are inserted into the corresponding first 353, 354, of the J-groove 351, 352, and when the locking sleeve 333 is rotated, the pins 361, 362, interface with and become secured within the second leg 355, 356, of the J-grooves 351, 352, to establish a rigid connection between the extension member 335-piston and the valve stem member 337-linear actuated valve, locking the relative axial position of the respective components.

According to the exemplary configuration, the locking sleeve 333 can include one or more pairs of recesses or holes (not shown) similar to those shown in FIG. 4, for example, sized and spaced apart to receive a tool such as, for example, tool 117 shown in FIG. 4, or one or more pairs of flats similar to those shown in FIG. 4, for example, can receive a wrench for rotating the locking sleeve 333. The body of the locking sleeve 333 can also include a plurality of radially oriented set-screw holes 371, 372, sized to receive a corresponding plurality of setscrews 373, 374, positioned to prevent inadvertent unlocking of the locking sleeve 333 from piston extension member 335 and valve stem member 337. The inner surface of the locking sleeve 333 can include a groove (not shown), for example, operably extending longitudinally between the ends of the sleeve 333 according to a pattern understood by one of ordinary skill in the art, or other pressure relief mechanism. In addition to or alternatively, a pressure relief groove (not shown), for example, can have portions in the outer surface of extension member 335 and portions in the outer surface of the valve stem number 337. One of the groove portions in one of the members 335, 337, can radially/diametrically and perpendicularly intersect with the other during operable engagement therebetween.

Note, the embodiments shown in FIGS. 8 and 9 can be combined to have, for example, one J-groove 251, 252 on the locking sleeve 233, 333 and one J-groove 351, 352, on either the extension member 235, 335, or the valve stem member 237, 337. Both methodologies, however, can provide a sliding fit at least to the standard described in ANSI B4.1-1967, section RC2, but more preferably to the standard described in section RC1, to thereby provide for establishing a precision fit with effectively no play therebetween sufficient to minimize undue vibrations and substantially extend the life of the pump and actuator components, at least well beyond that capable of other J-collar arrangements would be capable of achieving if so employed.

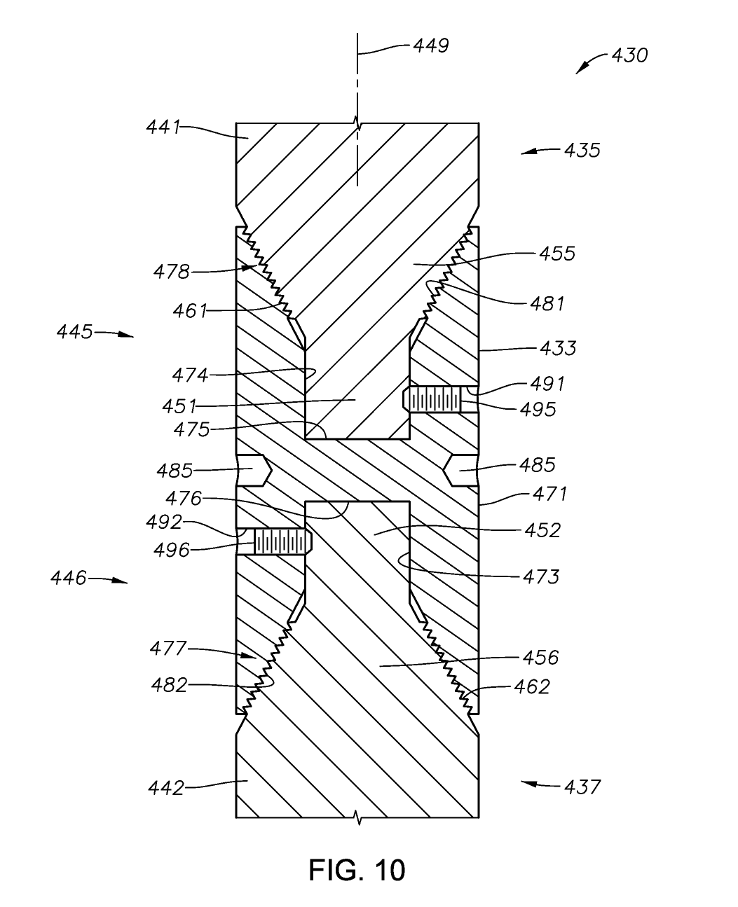

FIG. 10 illustrates an apparatus 430 for connecting a linear actuating mechanism of an actuator to a valve stem of a linearly actuated valve. According to the exemplary configuration, the apparatus 430 includes a threaded collar or coupling 433, a piston extension member 435, and a valve stem member 437. According to the exemplary configuration, the unitized actuator (see, e.g., actuator 31, FIG. 1) contains a piston (not shown) having a main body contained within a housing 41 of the actuator and the extension member 435 extending longitudinally therefrom, aligned coaxially with the main axis 449 of the main body of the piston. Note, according to the exemplary configuration, the extension member 435 and/or piston form part of the apparatus 430.

According to the illustrated configuration, the extension member 435 and valve stem member 437 each include a main body portion 441, 442, and a distal end portion 445, 446, including an interfacing end section 451, 452, and a frustoconical section 455, 456, located between the interfacing end section 451, 452, and the main body portion 441, 442. According to the exemplary configuration, the interfacing end section 451, 452, of each member 435, 437, is cylindrical in shape and has a diameter that is substantially smaller than that of the respective main body portions 441, 442, which is also typically at least substantially cylindrical in shape. The frustoconical sections 455, 456, include a conical thread-form profile 461, 462, to facilitate makeup.

Correspondingly, according to the illustrated configuration, the threaded coupling 433 has a typically cylindrical shaped body 471 having a first bore 473 and a second opposite coaxial bore 474 extending therein from opposite ends of the body 471, which each have a diameter matching the diameter of the interfacing end sections 451, 452. Each of the first and the second bores 473, 474 terminate into a substantially flat portion 475, 476. Further, a pair of frustoconically shaped ramp sections 477, 478, extend inward from the ends of the coupling 433. Each ramp section 477, 478, includes a conical thread-form profile 481, 482, complementing the conical thread-form profile 461, 462, of the frustoconical sections 455, 456, of the respective main body portions 441, 442, of the extension member 435 and the valve stem member 437.

According to the exemplary configuration, the thread-form profile 481 has right-hand threads and the thread-form profile 482 has left-hand threads so that when the coupling 433 is rotated clockwise, the respective ends of the coupling 433 are simultaneously threaded with the ends of the extension member 435 and the valve stem member 437. Note, although the conical thread-form can reduce make-up time, a standard thread-form and associated configuration can alternatively be employed. Also, in order to improve the speed and reduce the number of turns to create the connection, the thread-form profiles 461, 462, and 481, 482, can have a multiple thread start.

According to the exemplary configuration, the body 471 of the threaded coupling 433 can include one or more pairs of recesses or holes 485 sized and spaced apart to receive a tool such as, for example tool 117 shown in FIG. 4, or one or more pairs of flats 475, 476 to receive a wrench for rotating the coupling 433. The body 471 of the coupling 433 can also include a plurality of radially oriented set-screw holes 491, 492, sized to receive a corresponding plurality of setscrews 495, 496, positioned to prevent inadvertent unthreatening of the coupling 433. Note, one assembly alternative may include the direct threading of stem onto piston, or vice-versa. This, however, presents a challenge as either the valve or the actuator must be rotated to create the connection. This is not only generally considered impractical, but it also subjects the internal components of the actuator and valve to unnecessary loading.

According to an embodiment, apparatus 430 can include a pair of fluid vent and anti-pressure lock conduits (not shown) extending through the main body portions 441, 442 of extension and the valve stem members 435, 437, arranged similar to that of fluid vent and anti-pressure lock conduits 111 (FIG. 2). Alternatively, if employed, the pair of fluid vent and anti-pressure lock conduits can at least initially extend through the region between flats 475, 476, and then through one or more apertures extending through coupling 433. As another alternative, venting can occur via at least one, but more typically a pair of grooves (not shown) operably extending longitudinally between the ends of the coupling 433 according to a pattern understood by one of ordinary skill in the art, or other pressure relief mechanism. In addition to or alternatively, a pressure relief groove (not shown), for example, can have portions in the outer surface of piston and valve stem extension members 435, 437. One of the groove portions in one of the members 435, 437, can radially/diametrically and perpendicularly intersect with the other during operable engagement therebetween. Beneficially, the fit provided by the coupling can meet or exceed the standard described in ANSI B4.1-1967, section LC2, but more preferably to the standard described in section LC1.

When the actuator (see, e.g., actuator 31, FIG. 1) is assembled to the valve stem member 437, which is sandwiched between valve seats (not shown), it is not desirable to impart a torque on the linearly actuated valve or valve seats. Additionally, it is desired to avoid rotation of the whole actuator during make-up, not only because it is generally impractical, but because imparting work on associated seals may cause damage. As such, according to the exemplary configurations of apparatus 230, 330, and 430, in operation, the respective extension member 235, 335, 435, and valve stem member 237, 337, 437, are held and torque is applied to the respective sleeve or coupling 233, 333, 433. Since the actuator is generally in the stroked position during make-up to the valve, the reaction force of the spring 123 against the pressure end-load may be sufficient to hold the piston, and thus, may provide the means for holding the extension member 235, 335, 435, in a fixed angular position, negating the need for an additional tool to hold the extension member 235, 335, 435. Nevertheless, whether or not the extension member 235, 335, 435, is held through reaction force or through an external tool, the rotation of the extension member 235, 335, 435, of the various embodiments in relation to the valve stem member 237, 337, 437, or vice-versa, is not required and can advantageously be avoided during make-up.

In the drawings and specification, there have been disclosed a typical preferred embodiment of the invention, and although specific terms are employed, the terms are used in a descriptive sense only and not for purposes of limitation. The invention has been described in considerable detail with specific reference to these illustrated embodiments. It will be apparent, however, that various modifications and changes can be made within the spirit and scope of the invention as described in the foregoing specification. For example, although illustrated and described primarily with respect to application to unitized actuators, one of ordinary skill in the art would recognize that the apparatus and methods can be utilized in connecting non-unitized actuators to the valve stems of linearly actuated valves.

1. An apparatus for connecting a linear actuating mechanism of an actuator to a valve stem of a linearly actuated valve, the apparatus comprising:
a segmented locking member comprising a plurality of engagement members each including an inner surface profile configured to complement an outer surface profile extending along an outer surface portion of an outer surface of a valve stem member of a valve to lockingly engage therewith, and a tapered outer surface profile configured to engage inner surface portions of a tapered recess extending into an extension member of a linear actuating mechanism when urged therealong; and
a locking cap member configured to contain the segmented locking member, to receive distal end portions of the valve stem member, to receive portions of the extension member, and to urge the plurality of engagement members into slidable engagement with the inner surface portions of the tapered recess extending into the extension member and into locking engagement with the grooved outer surface profile extending along the outer surface portion of the outer surface of the valve stem member, during coupling of the locking cap member with the extension member.

2. An apparatus as defined in claim 1, wherein each of the plurality of engagement members include a circumferentially oriented bore extending through main body portions thereof and a support ring extending therethrough.

3. An apparatus as defined in claim 1,
wherein the inner surface profile of each of the plurality of engagement members comprises a plurality of circumferentially positioned ramp sections forming a surface contour, and
wherein the outer surface profile of the valve stem member comprises a plurality of annular ramp sections forming a surface contour that complements the surface contour of the plurality of annular oriented ramp sections.

4. An apparatus as defined in claim 1,
wherein the locking cap member has a first end portion, a second end portion, a main body portion extending therebetween, an aperture extending through a proximal-facing outer surface of the first end portion, sized to receive distal end portions of the valve stem member, and a bore extending longitudinally therein from the second end portion, substantially through the main body portion to receive portions of the extension member;
wherein the aperture has an inner diameter being substantially smaller than the inner diameter of portions of the bore adjacent thereto to thereby form an annular shoulder therewith sized to operably engage proximal-facing portions of the plurality of engagement members of the segmented locking member; and
wherein the bore has an inner surface profile extending along portions of the inner diameter, the inner surface profile of the bore configured to couple with an outer surface profile extending along a portion of an outer surface of the extension member to cause the annular shoulder to urge the plurality of engagement members into slidable engagement with the inner surface portions of the tapered recess and into locking engagement with the grooved outer surface profile of the valve stem member, during coupling of the locking cap member with the extension member.

5. An apparatus as defined in claim 1,
wherein the outer surface profile extending along a portion of the outer surface of the extension member comprises a threaded profile circumscribing a substantial portion of the outer surface of the extension member; and
wherein the inner surface profile of the bore of the locking cap member extending along portions of the inner diameter comprises a threaded profile extending longitudinally along substantial portions of the inner diameter, the threaded profile of the bore complementing the threaded profile circumscribing the substantial portion of the outer surface of the extension member to threadingly engage therewith during coupling thereto to thereby cause the annular shoulder to urge the plurality of engagement members into engagement with the inner surface portions of the tapered recess and into locking engagement with the grooved outer surface profile of the valve stem member, during coupling of the locking cap member with the extension member.

6. An apparatus as defined in claim 5, further comprising:
a washer or bearing having an aperture sized to receive the valve stem member and positioned between the proximal-facing portions of the plurality of engagement members of the segmented locking member and a distal-facing portion of the annular shoulder of the locking cap member.

7. An apparatus as defined in claim 5, further comprising:
a fluid vent and anti-pressure lock conduit in fluid contact with the bore extending into the extension member to provide fluid venting therefrom when the distal end portions of the valve stem member is inserted therein and to provide pressure equalization during extraction thereof.

8. An apparatus for connecting a linear actuating mechanism of an actuator to a valve stem of a linearly actuated valve, the apparatus comprising:
a segmented locking member comprising a plurality of engagement members each including a grooved inner surface profile configured to complement a grooved outer surface profile extending along an outer surface portion of an outer surface of an elongate valve stem member to lockingly engage therewith, and a tapered outer surface profile configured to engage inner surface portions of a tapered recess extending into an extension member of a linear actuating mechanism when urged therealong; and
a locking cap member having a first end portion, a second end portion, a main body portion extending therebetween, an aperture extending through a proximal-facing outer surface of the first end portion, and a bore extending longitudinally therein from the second end portion, substantially through the main body portion, the aperture having an inner diameter sized to receive distal end portions of the valve stem member and being substantially smaller than the inner diameter of portions of the bore adjacent thereto to thereby form an annular shoulder therewith sized to operably engage proximal-facing portions of the plurality of engagement members of the segmented locking member during coupling of the locking cap member with the extension member, the bore sized to receive portions of the extension member and having an inner surface profile extending along portions of an inner surface of the main body portion of the locking cap member, the inner surface profile of the bore configured to couple with an outer surface profile extending along a substantial portion of an outer surface of the extension member to thereby cause the annular shoulder to urge the plurality of engagement members into engagement with the inner surface portions of the tapered recess extending into the extension member and into locking engagement with the grooved outer surface profile extending along the outer surface portion of the outer surface of the valve stem member, during coupling thereof.

9. An apparatus as defined in claim 8, further comprising:
a washer or bearing having an aperture sized to receive the elongate valve stem member and positioned between the proximal-facing portions of the plurality of engagement members of the segmented locking member and a distal-facing portion of the annular shoulder of the locking cap member.

10. An apparatus as defined in claim 8, wherein each engagement member includes a circumferentially oriented bore extending through main body portions thereof and a support ring extending through, each of the plurality of engagement members.

11. An apparatus as defined in claim 10,
wherein the grooved inner surface profile of each of the plurality of engagement members comprises a plurality of annular oriented ramp sections forming a surface contour, and
wherein the grooved outer surface profile of the elongate valve stem member comprises a plurality of annular ramp sections forming a surface contour that complements the surface contour of the plurality of annular oriented ramp sections.

12. An apparatus as defined in claim 8,
wherein the outer surface profile extending along a substantial portion of the outer surface of the extension member comprises a threaded profile circumscribing the substantial portion of the outer surface of the extension member; and
wherein the inner surface profile of the bore extending longitudinally into the locking cap member is a threaded profile extending longitudinally along substantial portions of the inner diameter, the threaded profile of the bore complementing the threaded profile circumscribing the substantial portion of the outer surface of the extension member and configured to threadingly engage therewith during coupling thereto to cause the annular shoulder to urge the plurality of engagement members into engagement with the inner surface portions of the tapered recess and into locking engagement with the grooved outer surface profile.

13. An apparatus as defined in claim 8, further comprising:
a fluid vent and anti-pressure lock conduit in fluid contact with the bore extending into the extension member to provide fluid venting therefrom when the distal end portions of the valve stem member is inserted therein and to provide pressure equalization during extraction thereof.

14. An apparatus for connecting a linear actuating mechanism of an actuator to a valve stem of a linearly actuated valve, the apparatus comprising:
an elongate valve stem member of a valve including a grooved outer surface profile extending along an outer surface portion of an outer surface of the valve stem member;
a linear actuating mechanism of an actuator comprising a piston, the piston including a piston main body and an extension member extending longitudinally therefrom aligned coaxially with a piston body main axis, the extension member having a threaded profile circumscribing substantial portions of an outer surface thereof, and a bore extending therein aligned coaxially with the piston main body and sized to receive distal end portions of the valve stem member and to centralize the valve stem member longitudinally along the piston body main axis when the distal and portions of the valve stem member is inserted therein, and a tapered recess extending therein and coaxially therewith, having a tapered inner surface profile such that the inner diameter is larger at an entrance thereto than at inner surface portions thereof;
a segmented locking member comprising a plurality of engagement members each having a radially oriented bore extending through main body portions thereof and a support ring extending therethrough, each of the plurality of engagement members further including a grooved inner surface profile configured to complement the grooved outer surface profile extending along the outer surface portion of the outer surface of the valve stem member to lockingly engage therewith, each of the engagement members also having a tapered outer surface profile configured to engage inner surface portions of the tapered recess extending into the extension member when urged therealong;
a locking cap member having a first end portion, a second end portion, a main body portion extending therebetween, an aperture extending through a proximal-facing outer surface of the first end portion, and a bore extending longitudinally therein from the second end portion and substantially through the main body portion, the aperture sized to receive the distal end portions of the valve stem member and having an inner diameter being substantially smaller than the inner diameter of portions of the bore adjacent thereto to thereby form an annular shoulder therewith sized to operably engage proximal-facing portions of the plurality of engagement members of the segmented locking member, the bore sized to receive portions of the extension member and having a threaded profile extending along substantial portions of the inner diameter thereof, the threaded profile of the bore configured to complement the threaded profile circumscribing an outer surface portion of the outer surface of the extension member to threadingly engage therewith to thereby cause the annular shoulder to urge the plurality of engagement members into engagement with the inner surface portions of the tapered recess extending into the extension member and into locking engagement with the grooved outer surface profile extending along the outer surface portion of the outer surface of the valve stem member, when threaded thereon.

15. An apparatus as defined in claim 14, further comprising:
a washer or bearing having an aperture sized to receive the elongate valve stem member and positioned between the proximal-facing portions of the plurality of engagement members of the segmented locking member and a distal-facing portion of the annular shoulder of the locking cap member.

16. An apparatus as defined in claim 14, further comprising:
a fluid vent and anti-pressure lock conduit in fluid contact with the bore extending into the extension member to provide fluid venting therefrom when the distal end portions of the valve stem member is inserted therein and to provide pressure equalization during extraction thereof.

17. An apparatus as defined in claim 14,
wherein the grooved inner surface profile of each of the plurality of engagement members comprises a plurality of annular oriented ramp sections forming a surface contour, and
wherein the grooved outer surface profile of the elongate valve stem member comprises a plurality of annular ramp sections forming a surface contour that complements the surface contour of the plurality of annular oriented ramp sections.

18. An apparatus as defined in claim 14, wherein the actuator has an actuator housing; and wherein the piston main body is contained within the actuator housing.

19. A method of connecting a linear actuating mechanism of an actuator to a valve stem of a linearly actuated valve, the method comprising:
providing a segmented locking member comprising a plurality of engagement members each including an inner surface profile configured to complement an outer surface profile extending along an outer surface portion of an outer surface of an elongate valve stem member of a valve to lockingly engage therewith, and a tapered outer surface profile configured to engage inner surface portions of a tapered recess extending into an extension member of a linear actuating mechanism comprising a piston, when urged therealong;
providing a locking cap member configured to receive the segmented locking member, portions of the extension member, and distal end portions of the elongate valve stem member;
extending the distal end portions of the elongate valve stem member through an aperture in the locking cap member and through a passageway extending through the segmented locking member;
inserting the distal end portions of the elongate valve stem member into a bore extending into the extension member to align the elongate valve stem member coaxially with a piston main body to centralize the elongate valve stem member longitudinally along a piston body main axis; and
urging the tapered outer surface profile of the plurality of engagement members into engagement with the inner surface portions of the tapered recess extending into the extension member to thereby longitudinally slide the grooved inner surface profile of plurality of engagement members into locking engagement with the grooved outer surface profile of the valve stem member.

20. A method as defined in claim 19,
wherein each of the plurality of engagement members include a radially oriented bore extending through main body portions thereof and a support ring extending therethrough;
wherein the inner surface profile of each of the plurality of engagement members is a grooved inner surface profile comprising a plurality of annular oriented ramp sections forming a surface contour;
wherein the outer surface profile of the elongate valve stem member is a grooved outer surface profile comprising a plurality of annular ramp sections forming a surface contour that complements the surface contour of the plurality of circumferentially positioned ramp sections; and
wherein the method further comprises lockingly engaging the grooved inner surface profile of plurality of engagement members with the grooved outer surface profile of the valve stem member.

21. A method as defined in claim 19,
wherein the locking cap member includes a bore extending longitudinally therein substantially through a main body portion to receive portions of the extension member;
wherein the aperture has an inner diameter being substantially smaller than the inner diameter of the bore of the locking cap member adjacent thereto to thereby form an annular shoulder therewith sized to operably engage proximal-facing portions of the plurality of engagement members of the segmented locking member during coupling of the locking cap member with the extension member; and
wherein the bore has an inner surface profile extending along portions of the inner diameter thereof, the inner surface profile of the bore coupling with an outer surface profile extending along a portion of an outer surface of the extension member to cause the annular shoulder to urge the plurality of engagement members into slidable engagement with the inner surface portions of the tapered recess and into locking engagement with the grooved outer surface profile;
wherein the outer surface profile extending along a portion of the outer surface of the extension member comprises a threaded profile circumscribing a substantial portion of the outer surface of the extension member;
wherein the inner surface profile of the bore of the locking cap member extending along portions of the inner diameter thereof comprises a threaded profile extending longitudinally along substantial portions of the inner diameter, the threaded profile of the bore complementing the threaded profile circumscribing the substantial portion of the outer surface of the extension member to threadingly engage therewith during coupling thereto to thereby cause the annular shoulder to urge the plurality of engagement members into engagement with the inner surface portions of the tapered recess and into locking engagement with the grooved outer surface profile; and
wherein the step of urging the tapered outer surface profile of the plurality of engagement members into engagement with the inner surface portions of the tapered recess extending into the extension member includes rotating the locking cap member to thereby longitudinally slide the grooved inner surface profile of plurality of engagement members into locking engagement with the grooved outer surface profile of the valve stem member.

22. A method as defined in claim 19,
wherein the locking cap member includes a bore extending longitudinally therein substantially through a main body portion to receive portions of the extension member;
wherein the aperture in the locking cap member has an inner diameter being substantially smaller than the inner diameter of the bore of the locking cap member adjacent thereto to thereby form an annular shoulder therewith sized to operably engage proximal-facing portions of the plurality of engagement members of the segmented locking member; and
wherein the method further comprises:
inserting a washer or bearing within the bore of the locking cap member and into contact with a distal-facing portion of the annular shoulder of the locking cap member, the washer or bearing having an aperture sized to receive the elongate valve stem member, and
inserting the segmented locking member within the bore of the locking cap member, atop the washer or bearing, so that proximal-facing portions of the plurality of engagement members face a distal-facing surface of the washer or bearing.

23. A method as defined in claim 19, further comprising the step of:
releasing a locked connection between the valve stem member and the piston by removing the locking cap member, the removal releasing the locked engagement of the grooved inner surface profile of each of the plurality of engagement members with the grooved outer surface profile of the valve stem member.
